(19) United States
(12) Patent Application Publication
(10) Pub. No.: US 2008/0150486 A1
(43) Pub. Date: Jun. 26, 2008

(54) BATTERY HAVING UNIVERSAL SERIAL BUS CONNECTOR

(75) Inventors: Chen Kuan-Ting, Taipei City (TW); Teng Shu-Hsuan, Taipei City (TW); Tsai Ming-Sheng, Taipei City (TW); Liu You-Chi, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/762,066

(22) Filed: Jun. 13, 2007

(30) Foreign Application Priority Data
Dec. 20, 2006 (TW) 95147902

(51) Int. Cl. H02J 7/00

(52) U.S. Cl. 320/128; 320/135

(57) ABSTRACT

A battery having a universal serial bus (USB) connector is provided. The battery includes a battery control circuit, a voltage regulator circuit, a USB connector, and a device connector. The battery control circuit is used for providing a power source. The voltage regulator circuit is coupled to the battery control circuit, and used for regulating the voltage of the power source. The USB connector is coupled to the battery control circuit, and used for being connected with an external USB device and providing the power for the USB device. The device connector is coupled to the battery control circuit, used for being connected with a portable electronic device and providing the power for the portable electronic device. Therefore, the cost for purchasing subsidiary battery can be saved by using the battery of the present invention. The idea of implementing one battery with multipurpose also fits with economical benefit.

### CROSS-REFERENCE TO RELATED APPLICATION

This application claims the priority benefit of Taiwan application serial no. 95147902, filed Dec. 20, 2006. All disclosure of the Taiwan application is incorporated herein by reference.

### BACKGROUND OF THE INVENTION

1. Field of the Invention

The present invention relates to a battery. More particularly, the present invention relates to a battery having a universal serial bus (USB) connector.

2. Description of Related Art

Currently, the power supplying modes of portable electronic devices, such as a laptop, are classified into two types: in one type, the power is provided by an external power source supplier; and in the other type, the power is provided by a battery. For a laptop, the portability is important because most of the common using sites are in an outdoor environment. Under the condition that the external power source is not available, the power of the whole laptop can be supplied only by the battery mounted therein. Therefore, in order to maintain the normal operation of the laptop, the capacity of the battery is increased accordingly, so as to provide a constant and stable current to the laptop.

Additionally, with the development of electronic science and technology, various electronic products have been brought forth continuously, among which mobile phones, MP3 players, navigation devices are the hottest products. In order to attract consumers, the volumes of the portable devices are getting smaller and smaller, and the supported functions are diversified. However, multiple functions means high power consumption, thus the requirements for power source of this type of devices increases accordingly. The users tend to purchase subsidiary batteries or carry a charger to avoid the situation that the battery power is used up and the device cannot be used continually. For example, when one purchases a digital camera, he/she must purchase subsidiary batteries, otherwise he/she must carry a charger. These methods not only increase the burden of the user, but also bring inconvenience to the user.

In view of the above, the idea of the present invention is generated under the precondition of utilizing the existing high capacity battery to provide the power for charging the mini 3C products.

### SUMMARY OF THE INVENTION

Accordingly, the present invention is directed to provide a battery having a USB connector, which can provide other USB devices with the power needed in the operation thereof by additionally disposing a USB connector on the battery of a portable electronic device.

As described above and embodied broadly herein, the present invention provides a battery having a USB connector. The battery includes a battery control circuit, a voltage regulator circuit, a USB connector, and a device connector. The battery control circuit is used for providing a power source, and the voltage regulator circuit is coupled to the battery control circuit, and used for regulating the voltage of the power source. Additionally, the USB connector is coupled to the battery control circuit, and used for being connected with external USB device and providing the power for the USB device. The device connector is coupled to the battery control circuit, and used for being connected with the portable electronic device, and providing the power for the portable electronic device. The battery is disposed in a battery base of the portable electronic device.

In the battery having a USB connector according to an embodiment of the present invention, the battery control circuit is further used for receiving a charging current provided by the portable electronic device through the device connector for charging the battery.

In the battery having a USB connector according to an embodiment of the present invention, the portable electronic device includes a laptop, a mobile phone, or a personal digital assistant.

The battery having a USB connector according to an embodiment of the present invention further includes a switch, which is connected with battery control circuit in series, and used for turning on or turning off the power provided to the USB connector.

The battery having a USB connector according to an embodiment of the present invention further includes an indicator, which is connected with the battery control circuit and the switch in series, and used for indicating power supply status of the battery control circuit.

The battery having a USB connector according to an embodiment of the present invention further includes an automatic load detecting circuit, which is connected with the battery control circuit and the USB connector in parallel, for detecting a load of the USB connector. When the load is detected, the battery control circuit is controlled to provide the power for the USB connector, if no load is detected, the battery control circuit is stopped from providing the power. The voltage regulator circuit is connected with the battery control circuit in parallel or in series.

In the present invention, a structure with a USB connector disposed on a battery of a portable electronic device is adopted, so that the battery can not only provide the power for the portable electronic device, but also can provide the power for other connected USB devices, thus the battery having USB connector of the present invention is convenient, economic, and practical.

In order to the make aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a battery having a USB connector according to an embodiment of the present invention.

FIG. 2 is a circuit block diagram of a battery having USB connector according to an embodiment of the present invention.

FIG. 3 is a circuit block diagram of the battery having USB connector according to another embodiment of the present invention.

FIG. 4 is a circuit block diagram of the battery having USB connector according to still another embodiment of the present invention.

### DESCRIPTION OF EMBODIMENTS

Generally, in order to provide a constant and stable current to the computer for maintaining the normal operation of the computer, it is necessary for the battery of laptops to relatively increase the capacity thereof. Accordingly, this type of battery can store a huge amount of power for matching the light, thin, short, and small features of laptop. The volume of the battery is correspondingly reduced for being easily carried by the user. The present invention utilizes this characteristic and additionally disposes one or more USB connectors on this type of battery, so that the user can freely connect USB devices, such as a mobile phone, a camera and a MP3 player, with the power source, thereby normally operating the devices or charging the batteries of the devices. In order to make the content of the present invention more comprehensible, embodiments are taken as the examples which the present invention is implemented accordingly.

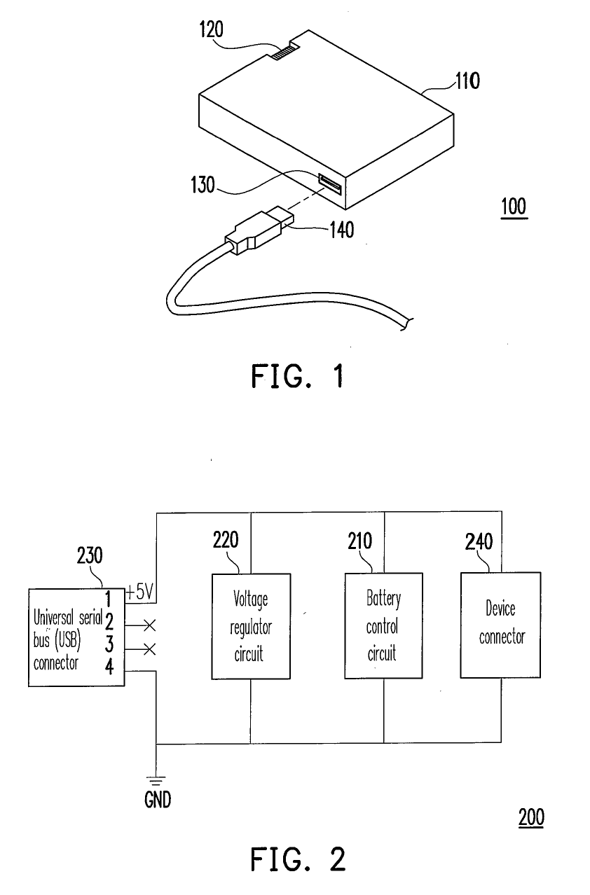

FIG. 1 is a perspective view of a battery having a USB connector according to an embodiment of the present invention. Referring to FIG. 1, the battery 100 of the embodiment includes a battery body 110. Besides a connector 120 for initially connecting with a portable electronic device, the battery body 110 further includes a newly disposed USB connector 130. The USB connector 130 meets the voltage standard of a common universal serial bus, and provides the power for a USB device (not shown) through a USB cable 140.

FIG. 2 is a circuit block diagram of a battery having USB connector according to an embodiment of the present invention. Referring to FIG. 2, a battery 200 of the embodiment includes a battery control circuit 210, a voltage regulator circuit 220, a USB connector 230, and a device connector 240. The battery 200 is suitable for being disposed in a battery base of a portable electronic device (for example, a laptop (not shown)), so as to provide the power needed in the operation of the portable electronic device. Additionally, the battery 200 can also independently provide the power for a USB device (not shown), which is not limited in the present invention.

The battery control circuit 210 includes, for example, a plurality of battery cells, and is suitable for providing sufficient power. The voltage regulator circuit 220 is connected with the battery control circuit 210 in parallel for regulating the voltage of the power provided by the battery control circuit 210. The voltage is, for example, 5 volts direct current voltage meeting the USB standard, which is not limited in the present invention.

In addition, the USB connector 230 is coupled to the battery control circuit 210 for an external USB device (not shown) to insert, and provides the power for the USB device.

In another aspect, the device connector 240 is also coupled to the battery control circuit, and when the battery 200 is placed in the portable electronic device (not shown), the device connector 240 is connected with the corresponding connector on the battery base of the portable electronic device, thereby providing the power for the portable electronic device. Meanwhile, if the power of the battery 200 is insufficient, the battery 200 can be charged by an external power source of the portable electronic device through the connection of the portable electronic device.

Besides the function of providing the power for the portable electronic device, the above described battery 200 further has a function of providing the power for the USB device, and is capable of providing the power for the two simultaneously or one of them individually. Therefore, the battery 200 is not merely a common battery, but also can further serve as a mobile power source, which can provide the user a convenient and economical power.

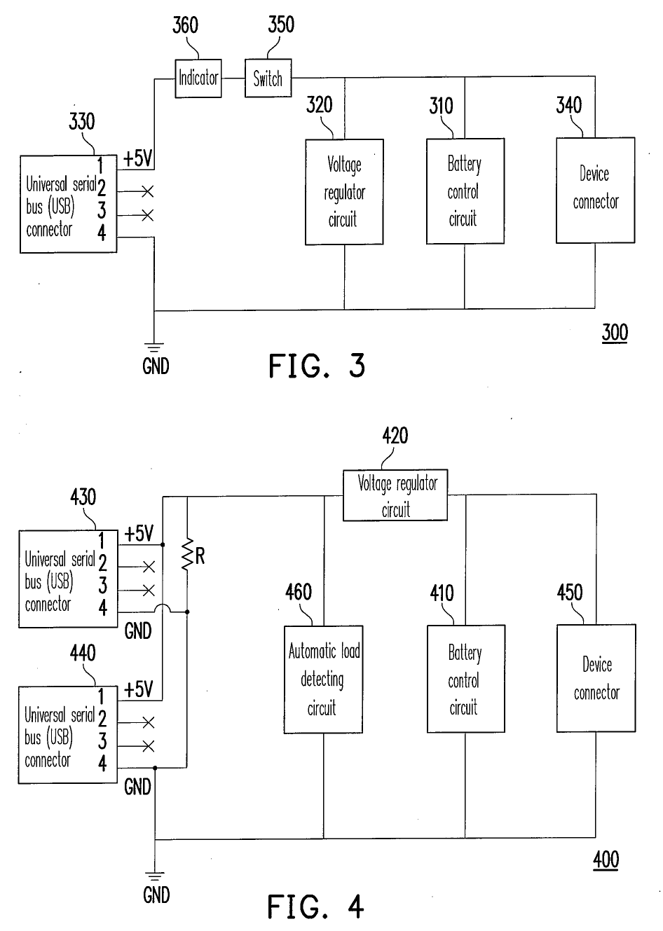

FIG. 3 is a circuit block diagram of the battery having USB connector according to another embodiment of the present invention. Referring to FIG. 3, in addition to a battery control circuit 310, a voltage regulator circuit 320, a USB connector 330, and a device connector 340, a battery 300 of the embodiment further includes a switch 350 and an indicator 360. The connections and functions of the battery control circuit 310, the voltage regulator circuit 320, the USB connector 330, and the device connector 340 are similar to those of the battery control circuit 210, the voltage regulator circuit 220, the USB connector 230, and the device connector 240 according to the previous embodiment, and will not be described in detail herein.

The switch 350 is connected with the battery control circuit 310 in series for turning on or turning off the power provided to the USB connector 330. Subsequent to the switch 350, the indicator 360 is connected in series for indicating the power supply status of the battery control circuit 310. The propose of disposing the switch 350 is to turn off the power provided to the USB connector 330 in case that no USB device is connected with the USB connector 330, so as to avoid the power consumption due to the continuous turning on of the USB connector 330. The switch 350 can be a simple switching button, such that the user can turn on the battery 300 to provide the power as demanded. Relatively, the indicator 360 can indicate whether the USB connector 330 is currently in a power supply status or not, and can indicate the magnitude of electricity currently remained in the battery, so as to provide a reference to the user upon using the battery.

FIG. 4 is a circuit block diagram of the battery having USB connector according to another embodiment of the present invention. Referring to FIG. 4, a battery 400 of the embodiment also includes a battery control circuit 410, a voltage regulator circuit 420, two USB connectors 430, 440, and a device connector 450. The only exception is that the voltage regulator circuit 420 is connected with the battery control circuit 410 in series. Additionally, according to this embodiment, an automatic load detecting circuit 460 is newly disposed, which is capable of detecting the variation of the loads of the USB connectors 430, 440, thereby controlling the magnitude of the electricity provided by the battery control circuit 410 to the USB connectors 430, 440. If no load is detected on the USB connectors 430, 440, it can be determined that the USB connectors 430, 440 have not been connected with other USB devices, thus the battery control circuit 410 is stopped from providing the power, so as to save power. It should be noted that, in this embodiment, the battery 400 includes two USB connectors 430, 440, such that it can be connected with two USB devices simultaneously. However, this embodiment does not limit the number, type (adaptor size), and edition (USB 1.1 or 2.0) of the USB connectors. Therefore, the user can select and dispose different number, different types of USB connectors on the battery according to the actual requirements.

In view of above, the battery having a USB connector according to the present invention at least has the following advantages.

1. By using the existing battery of the portable electronic device, the power can be provided for the portable electronic device and other USB devices at the same time, such that the cost for purchasing a new battery is saved, which is economical and practical.

2. The battery of the portable electronic device meets the requirements of light, thin, short, and small, and thus being suitable for being carried without adding the burden of the user.

3. By controlling the power provided for the USB connector with a switch or an automatic load detecting circuit, the power can be duly turned off when the USB connector is not used, thereby saving the power consumption.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A battery having a universal serial bus (USB) connector, comprising:
a battery control circuit, for providing a power source;
a voltage regulator circuit, coupled to the battery control circuit, for regulating voltage of the power source;
a USB connector, coupled to the battery control circuit, for being connected with an external USB device, and providing power for the USB device; and
a device connector, coupled to the battery control circuit, for being connected with a portable electronic device, and providing the power for the portable electronic device.

2. The battery having a USB connector as claimed in claim 1, wherein the battery is disposed in a battery base of the portable electronic device.

3. The battery having a USB connector as claimed in claim 1, wherein the battery control circuit is further used for receiving a charging current provided by the portable electronic device through the device connector for charging the battery.

4. The battery having a USB connector as claimed in claim 1, wherein the portable electronic device comprises a laptop, a mobile phone, or a personal digital assistant.

5. The battery having a USB connector as claimed in claim 1, further comprising:
a switch, connected with the battery control circuit in series, for turning on or turning off the power provided to the USB connector.

6. The battery having a USB connector as claimed in claim 5, further comprising:
an indicator, connected with the battery control circuit and the switch in series, for indicating power supply status of the battery control circuit.

7. The battery having a USB connector as claimed in claim 1, further comprising:
an automatic load detecting circuit, connected with the battery control circuit and the USB connector in parallel, for detecting a load of the USB connector, wherein when the load is detected, the battery control circuit is controlled to provide the power for the USB connector, otherwise, the battery control circuit is stopped from providing the power.

8. The battery having a USB connector as claimed in claim 1, wherein the voltage regulator circuit is connected with the battery control circuit in parallel or in series.

9. The battery having a USB connector as claimed in claim 1, wherein the battery control circuit comprises a lithium battery or a nickel-hydrogen battery.
